(19) United States
(12) Patent Application Publication
(10) Pub. No.: US 2009/0310522 A1
(43) Pub. Date: Dec. 17, 2009

(54) WIRELESS SYNCHRONIZATION OF BASE STATIONS

(76) Inventors: James G. Bertonis, Los Gatos, CA (US); Geoffrey L. Giese, Santa Clara, CA (US)

Correspondence Address: Silicon Valley Patent Group LLP, 18805 Cox Avenue, Suite 220, Saratoga, CA, 95070, US

(21) Appl. No.: 12/137,552

(22) Filed: Jun. 12, 2008

(51) Int. Cl. H04L 5/14

(52) U.S. Cl. 370/280

(57) ABSTRACT

A method and apparatus to reduce and eliminate co-channel and/or adjacent channel interference without using a dedicated timing wire connected to each base station are provided. Base stations are synchronized using a master/slave architecture where slave base stations monitor transmit signals from a master base station to acquire coordinated and synchronized base station timing.

### CROSS-REFERENCE TO RELATED APPLICATIONS

Not applicable.

### BACKGROUND OF THE INVENTION

1. Field of the Invention

The invention relates generally to wireless telecommunications technology and more specifically to wirelessly synchronizing base stations in a mobile radio system.

2. Background of the Invention

Broadband wireless base station hubs, base transceiver stations (BTSs), outdoor units (ODUs), and micro-base stations are frequently co-located at the same physical location, and often attached to the same pole. The co-located WiMAX standard outdoor base stations are an example of such a configuration.

A typical wireless mode of operation is time-division-duplex (TDD) mode, which allows the same channel frequency to be used for both transmit and receive states, dividing the time between transmit and receive. Often the channel frequency is reused for base station sectors pointing 180 degrees from one another. Adjacent sectors will use different channel frequencies but usually in the same general band and near in percentage terms from each other.

When these multiple BTS units are operating in TDD mode at the same location, there is the possibility of the units interfering with each other. The units using the same frequency, although facing opposite directions, may have signal reflections from each other from objects in the outdoor environment. That is, a signal from a first BTS may be received by a second BTS after reflecting off of one or more of these objects. If the TDD timing is not identical in duty cycle and phase, reflections from a transmitting unit will, from time to time, enter the antenna of the receiving unit. This interference will limit each unit's range and sensitivity.

Secondly, units which are adjacent to each other, and on different but near channel frequencies, will also interfere with each other. Although the transmitters are channel-band filtered, this adjacent channel interference occurs because of the very high field strength present at a receiver when in close proximity of a transmitting unit. The antenna of an adjacent unit will receive an amount of transmitted signal from the other unit, and despite the band pass filtering, some signal energy will penetrate from the transmitting unit into the passband of the receiving unit. This will limit each unit's range and sensitivity.

Therefore, a need exists to reduce or eliminate these problems on interference, for example, by TDD phase synchronization. In such synchronized systems, all units transmit during a first set of time slots and receive during a second set of time slots. Thus interference caused by one base station unit's transmitter to another co-located base station unit's receiver is reduced or eliminated.

### SUMMARY

A method and apparatus to reduce and eliminate co-channel and/or adjacent channel interference without using a dedicated timing wire connected to each base station are provided. Base stations are synchronized using a master/slave architecture where slave base stations monitor transmit signals from a master base station to acquire coordinated and synchronized base station timing.

Some embodiments of the present invention provide for a method of synchronizing co-located wireless base stations, the method comprising: receiving, during a training mode at a wireless receiver of a first base station, a first wireless signal transmitted from a second base station; detecting an envelope of the first wireless signal; determining a transmit-receive schedule based on the detected envelope; switching from the training mode to an operational mode after the act of determining the transmit-receive schedule; transmitting, during a first duration determined by the transmit-receive schedule, a downlink signal; and receiving, during a second duration determined by the transmit-receive schedule, an uplink signal.

These and other aspects, features and advantages of the invention will be apparent from reference to the embodiments described hereinafter.

### BRIEF DESCRIPTION OF THE DRAWINGS

Embodiments of the invention will be described, by way of example only, with reference to the drawings.

FIG. 1 shows a wireless network including three base stations.

FIG. 2 shows transmission and reception envelopes for both a first base station and a second base station interfering with one another.

FIG. 3 illustrates multiple co-located base stations, in accordance with embodiments of the present invention.

FIG. 4 illustrates overlapping transmissions in the frequency domain of two base station.

FIG. 5 shows a system for wired synchronization of three base stations in a wireless system.

FIG. 6 shows transmission envelopes from three base stations in a synchronized network.

FIG. 7 shows a system for wireless synchronization of three base stations in a wireless system, in accordance with embodiments of the present invention.

FIG. 8 shows a mobile station in operation with three wirelessly synchronized base stations in a wireless system, in accordance with embodiments of the present invention.

FIG. 9 illustrates master detection during a training session by a slave, in accordance with embodiments of the present invention.

FIG. 10 is a block diagram of the RF paths in a receiver, in accordance with embodiments of the present invention.

FIGS. 11, 12 and 13 show flowcharts for a BTS training process and an operation mode, in accordance with embodiments of the present invention.

### DETAILED DESCRIPTION OF THE INVENTION

In the following description, reference is made to the accompanying drawings, which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense. Furthermore, some portions of the detailed description that follows are presented in terms of procedures, steps, logic blocks, processing, and other symbolic representations of operations on data bits that can be performed in electronic circuitry or on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in electronic circuitry or in a computer system. These signals may be referred to at times as bits, values, elements, symbols, characters, terms, numbers, or the like. Each step may be performed by hardware, software, firmware, or combinations thereof.

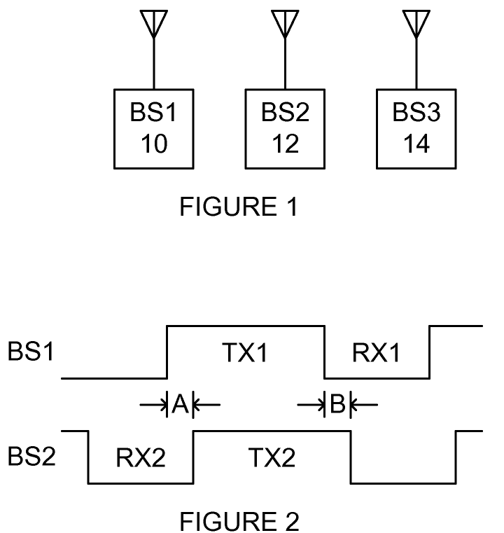

FIG. 1 shows a wireless network including three base stations (BS1 10, BS2 12 & BS3 14). Often multiple micro-base stations or base station ODUs are co-located at the same physical location. Co-located base station may be sectorized and from a single wireless network provider. Alternatively, co-located base stations may be from multiple providers sharing the same physical space for their equipment. In either case, a significant drawback to closely positioned base stations is that one base station's transmitter may generate inference for another base station's receiver if the base stations are not synchronized.

FIG. 2 shows transmission and reception envelopes for both a first base station and a second base station interfering with one another. A first base station BS1 has a duty cycle including a transmit envelope (TX1) of a first duration and a receive envelope (RX1) of a second duration. Similarly, a second base station BS2 has a duty cycle including a transmit envelope (TX2) of a first duration and a receive envelope (RX2) of a second duration. If the transmit envelope of one base station overlaps with the receive envelope of another base station, then the receiving base station may have substantially reduced sensitivity during the overlap. For example, during a period “A” while BS1 is transmitting and BS2 is receiving, BS2 will be unable to receive signals from distant mobile stations and perhaps unable to receive signals from any mobile station. Likewise, when BS2 transmits and BS1 receives during the period labeled “B”, BS1 will be unable to receive signals from mobile stations otherwise receivable. One method to reduce or eliminating such interference is separate the transmit and receive signals in the time domain. That is, base stations are synchronized such that no base station transmits while another receives. Another method is to separate the transmit and receive signals in the frequency domain as described below.

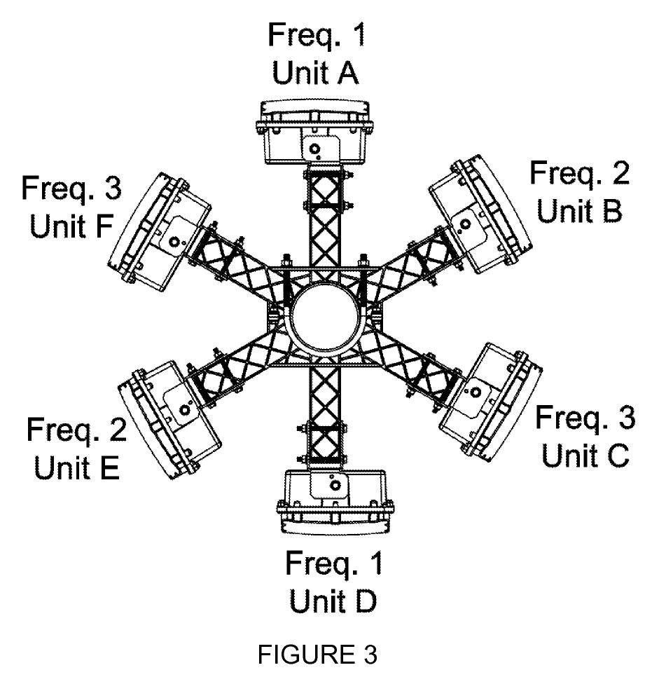

FIG. 3 illustrates multiple co-located base stations, in accordance with embodiments of the present invention. Six co-located base stations with respective directional antennas are co-located on one tower and configured in a six-sector configuration. The six base stations (Units A-F) may implement frequency reuse. For example, if two frequencies are available, one base station may use a first frequency and base stations for the respective neighboring-sectored base stations may us a common second frequency. As a result, alternating sectors use the same frequency thereby leaving a physical gap between antenna beam patters. A second example, as shown in the figure, uses three frequencies. For example, Units A, B and C use frequencies 1, 2 and 3, respectively. Frequencies 1, 2 and 3 are reused by Units D, E and F, respectively. As a result, frequency 1 is used by Units A and D, which face opposite directions.

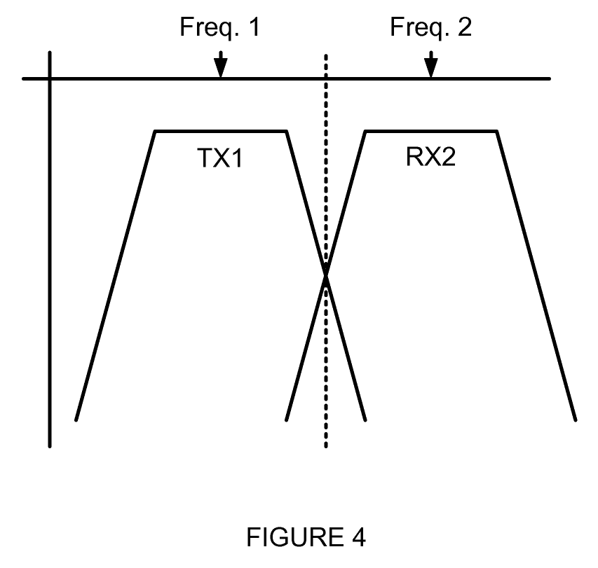

FIG. 4 illustrates overlapping transmissions in the frequency domain of two base stations. A first base stations is configured to operate within a first frequency band (centered at Freq. 1) and a second base stations is configured to operate within a second frequency band (centered at Freq. 2). As is shown, adjacent channels overlap at the band edges. Such an overlap may also cause interference (known as adjacent channel interference) when the first base stations is transmitting a signal (TX1) while the second base station is attempting to receive a signal (RX2). If TX1 overlaps in time with RX2, then the receiver in the second base station may become less sensitive to remote mobile stations.

Such separation still has the possible disadvantage of a transmit signal interfering with a receive signal. For example, a transmitted signal may be reflected from one building facing the antenna of the transmitter to another building facing the antenna of a receiver. Also, a directional antenna may have side lobes that transmit a signal in the direction of another antenna. In either case, frequency reuse may be inadequate to eliminate interference between a first base station transmitting and a second base station simultaneously receiving.

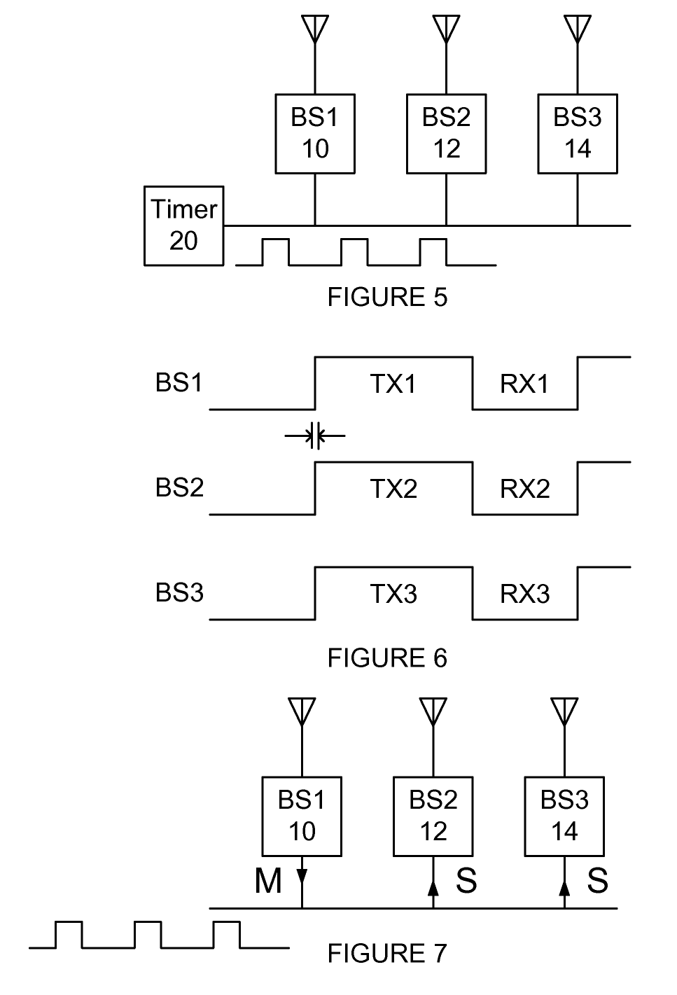

FIG. 5 shows a system for wired synchronization of three base stations in a wireless system. One solution to drastically reducing or eliminating interference from a base station's transmitted signal and another base station's received signal is to synchronize transmission and reception operations. FIG. 5 shows three base stations (BS1 10, BS2 12 and BS3 14) and a timer module 20. The base stations 10, 12 and 14 each have an additional input port, which is connected to the timer module 20 by a physical wire. The timer module 20 generates a wave form that each base station may use to coordinate simultaneous transitions.

FIG. 6 shows transmission envelopes from three base stations in a synchronized network. The three base stations (BS1, BS2 and BS3) each transmit a respective signal TX1, TX2 and TX3 during a first common period of time. Similarly, BS1, BS2 and BS3 each receive respective signals RX1, RX2 and RX3 during a second common period of time. Therefore, the overlap in time between a time when a first base station is in a transmit mode and a second base station is a receive mode is substantially minimized.

FIG. 7 shows a system for wireless synchronization of three base stations in a wireless system, in accordance with embodiments of the present invention. Unlike the base stations described above with respect to FIG. 5, the base stations of FIG. 7 do not require an external timer 20. The external timer 20 may acquire and keep timing from an internal high precision components or from an external source such as provided by a GPS receiver or a network timing protocol (NTP), which require an external connection.

A first base station BS1 10 is configured as a master base station “M”. Additional base stations (BS2 12 and BS3 14) are configured as slaves. The base stations 10, 12 and 14 also contain an additional port used for timing. The master base station 10 is configured to generate a timing signal, which it supplied from an output port. The slave base stations 12 and 14 include an extra input port and are physically connected to the master base station 10 with a wire to accept the timing signal. One disadvantage to this configuration is that base stations must each include an extra input and/or output port and they must be physically wired together.

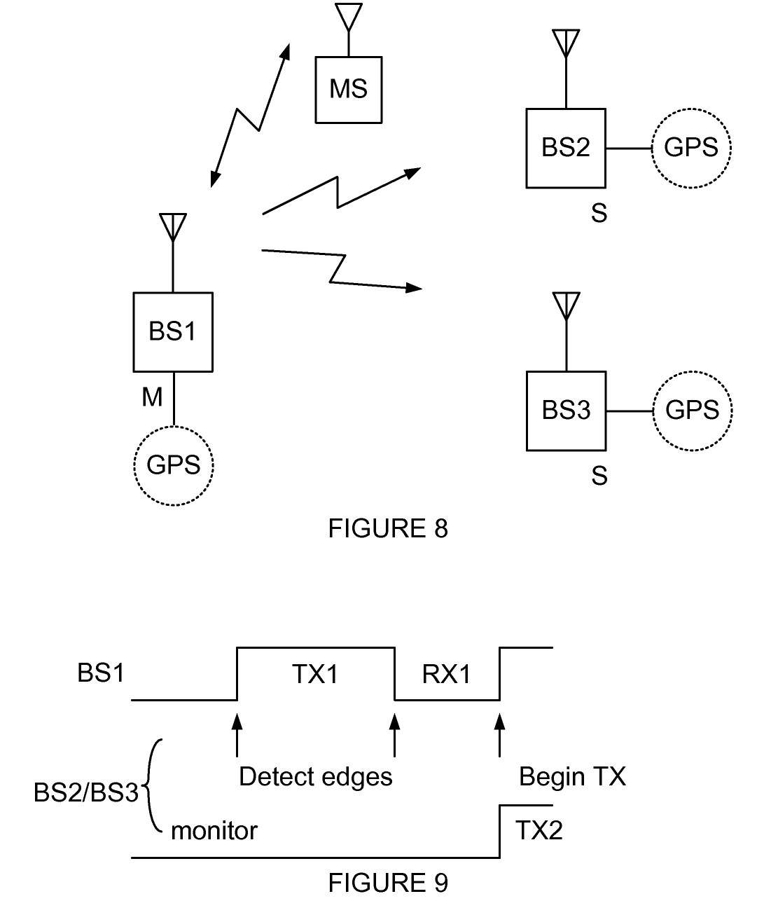

FIG. 8 shows a mobile station in operation with three wirelessly synchronized base stations in a wireless system, in accordance with embodiments of the present invention. A first base station (BS1) is configured as a master “M”. Additional base stations (BS2 and BS3) are configured as slaves “S”. A master base station generates a signal the each of the slave base stations may reference for timing of their individual transmit and receive modes.

Unlike the configurations described above, the present invention does not use additional input and/or output ports to send and receive a timing signal. Instead, a timing signal is extracted from the communication signal from the master base station. Once a timing signal is established by a slave base station, the timing signal may be maintained by an internal clock. Other systems obtain and maintain timing by use of a signal from one or more GPS satellites received at the base stations by a GPS receiver, where this invention serves as either a substitute for GPS timing or as a back-up system in the event of a GPS system failure. Embodiments of the present invention generally preclude the need and expense of a GPS receiver and other network timing protocol to maintain timing in the base stations.

FIG. 9 illustrates master detection during a training session by a slave, in accordance with embodiments of the present invention. The first base station BS1 configured as a master base station transmits and receives signals as shown. The second and third base stations BS2 and BS3 each monitor the BS1 signal to determine transmission and reception envelope edges. Once a sufficient number of edges are detected (e.g., enough to stabilize a PLL clock), the slave begin transmitting their signals in unison with the master base station BS1.

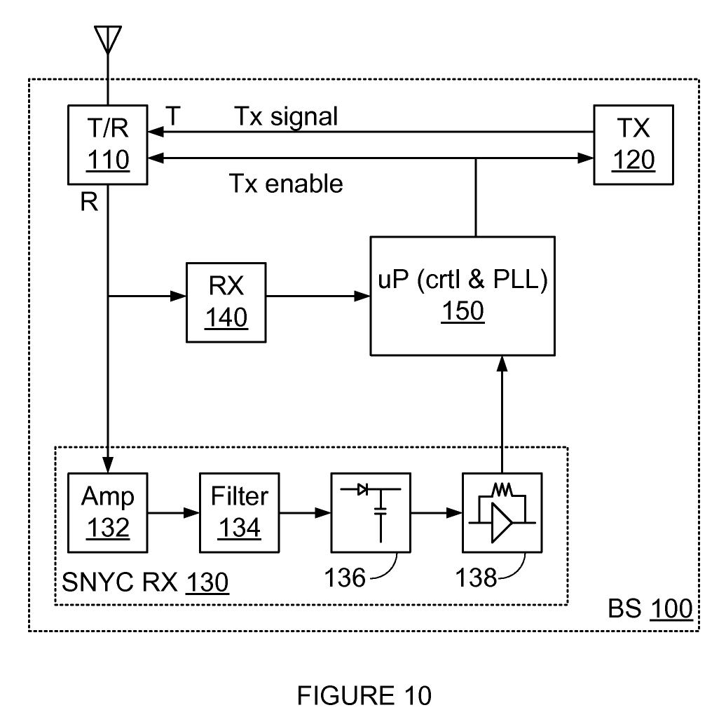

FIG. 10 is a block diagram of the RF paths in a receiver, in accordance with embodiments of the present invention. A base station 100 includes a transmit/receive switch T/R 110, a transmitter TX 120 that generates a transmit signal, a receiver RX 140 that down converts and demodulates a received signal and a processor uP 150 processes incoming demodulated signals and generates outgoing transmit signal as well as a transmit/receive control signal (Tx enable). Each of these components is used during an operational mode. During a training mode the receiver 140 is functionally replaced with a synchronization receiver SYNC RX 130, which accepts a receive signal from the switch 110. SYNC RX 130 acts as an envelope detector and provides an envelop wave form to processor 150. Switch 110 includes an input port “T” connected to an output port of the transmitter TX 120 and an output port “R” connected to an input port of the receivers 130 and 140. The switch 110 also includes an input/output port connected to an antenna and a control input port to accept a Tx enable from the processor 150.

The processor 150 may be implemented with a standard microprocessor, a microcontroller, one or more VLSI component, configurable logic containing programmable gates or dedicated circuitry. The processor 150 may include build-in phase locked loop (PLL) circuitry implemented in hardware and/or software. Alternatively, a PLL may be implemented separately from the processor 150 or may be implemented with other timer circuitry.

The receiver RX 130 is shown containing an amplifier Amp 130, a filter 134, a rectifier circuit 136 and a comparator circuit 138. In a slave training mode, an RF circuit is passed from the antenna through the switch 110 to the receiver 130. The signal is amplified by Amp 130 and filtered by filter 134. Components in receivers 130 and 140 may be shared. For example, a single amplifier 130 may be shared by bother receivers 130 and 140.

When the signal is passed through the rectifier circuit 136, the output is a pulse representative of the received signal in duration. The output of filter 134 is coupled to rectifier circuit 136 to remove RF and AC components of the raw signal. The output of rectifier circuit 136 is forwarded to a comparator 138 for further amplification to drive subsequent circuitry and to ensure the rising and falling edges are clean and sharp. In turn, the output of comparator 138 is forwarded as an input signal to the processor 150. The processor 150 applies the signal, which will resemble an envelope of the received signal, to timer recovery circuitry such as to a PLL. The input to the PLL or the output from the PLL may need to be delayed to account for processing delay in the transmit and receive paths. The output from the timer recovery circuitry (PLL) may be used as the Tx enable signal once the receiver switches from a monitoring or training mode to an operational mode.

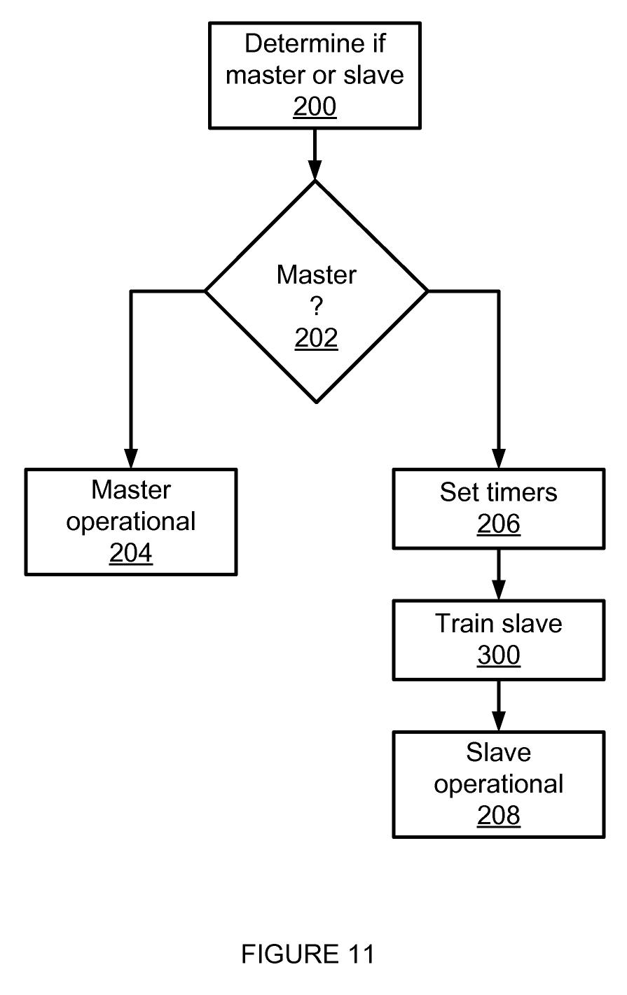

FIGS. 11, 12 and 13 show flowcharts for a BTS training process and an operation mode, in accordance with embodiments of the present invention. In FIG. 11 beginning at 200, a base station determines if it is configured as a master or a slave. At 202, if the base station determines it configured as a master, processing continues at 204. If not, processing continues at 206. At 204, the base station begins an operational mode as a master. That is, the duty cycle and phase of its transmit and receive signals are determined by an internal parameter, which may be configurable. At 206, optional timers may be set to allow the slave base station to know when to exit a training mode and begin an operational mode or similarly to know when to exit an operational mode and begin a training mode.

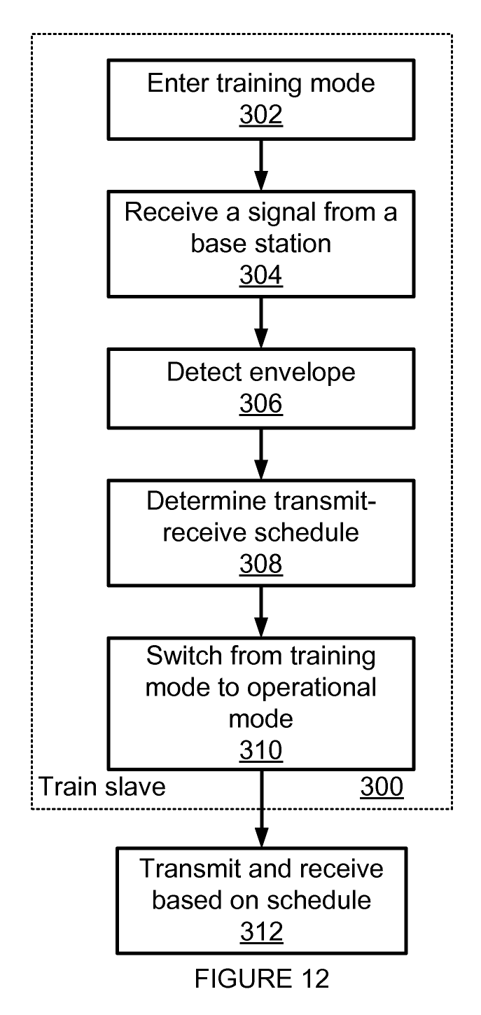

At 300, the slave base station enters a training mode (described further in relation to FIG. 12) to determine a transmit/receive schedule of a master slave. At 208, the slave base station exits the training mode and enters an operational mode where it transmits and receives signals according to the detected master's T/R schedule.

In some embodiments, a base station determines it is configured in a slave base station mode then delays for a predetermined about of time and finally enters a training mode. In other embodiments, a base station generates a random number representing a time sufficient train the base station. If no master base station signal is detected (i.e., no envelope is detected) then the base station converts from a slave base station to a master base station. In this way, all co-located base stations may be configured as slave base stations. When the first slave base station times out, it will define itself as the master base station for the group of co-located base station. The other slave base station, with a random number representing longer amounts of time, will then detect the newly configured master base station and complete the training process.

FIG. 12 shows a method of synchronizing co-located wireless base stations. At 302, one of the multiple located wireless base stations (a first base station acting as a slave base station) enters a training mode. During the training mode, the slave base station disables its transmitter, for example, by a processor 150 selecting a receive mode from T/R switch 110 as shown in FIG. 10. At 304, the slave base station receives a wireless signal transmitted from a second base station acting as a master base station.

At 306, the slave base station detects an envelope of the first wireless signal from the master base station, for example, using the circuitry from SYNC RX 130 and processor 150 of FIG. 10. The processor 150 detects the rising and falling edges. Either the rising or falling edge may be used to energize a PLL, or equivalent circuitry or software, at the rate of the detected envelope. The processor 150 may use the difference in time between the rising and falling edges to determine a duty cycle if one is not already pre-configured in the slave bases station. That is, the slave base station may determine a first duration of time based on a duration between a first and a second edge of the detected envelope and determine a second duration of time based on a duration between a second and a subsequent first edge of the detected envelope, thereby, determining and saving a duty-cycle parameter based on the first and second durations. For example, a detected envelope that has 5 units of time between a rising edge and a falling edge and 3 units of time between a falling edge and a rising edge would be interpreted as having a 5:3 duty cycle where a base station transmits for 5 units of time followed by 3 units of time where the base station receives.

Alternatively, a duty cycle parameter may be pre-configured into the slave base station. In this case, the processor 150 determines a start-of-transmission time but access the pre-configured parameter to determine the duty cycle. In some embodiments, the processor 150 determines both a frequency and a phase of the detected envelope. In other embodiments, the processor 150 determines a phase of the detected envelope but the frequency is pre-configured as a parameter the processor 150 may use to set the PLL frequency.

At 308, the slave base station determines a transmit-receive schedule based on the detected envelope. For example, the processor 150 uses the determined duty cycle and an edge to determine when signals at the slave base station will be transmitted and received. The transmit-receive schedule may be used to synchronize a start-of-transmission time at the slave base station to an edge of the detected envelope. At 310, the slave base station switching from the training mode to an operational mode after the transmit-receive schedule is determined. At 312, the slave base station begins transmitting a downlink signal during a first duration determined by the transmit-receive schedule and receives an uplink signal during a second duration also determined by the transmit-receive schedule.

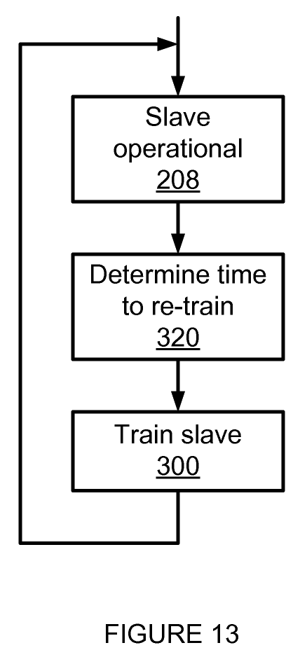

FIG. 13 shows a process to re-synchronize the slave base station. Without an external synchronization signal (such as provided by the timer 20 of FIG. 5, the master base station 10 of FIG. 7), a slave base station may drift with time. That is, the phase of the base station signal may become increasingly out of phase with the master base station.

One way to reduce an accumulation of drift is to force the re-synchronization process, for example, periodically or based on a detecting a symptom of drift. For example, by detecting an invalid envelope during an operational mode, the slave base station my re-initiating the training mode and begin receiving a subsequent wireless signal transmitted from the master base station. An invalid envelope may appear when a high power transmit signal is detected by the receiver during the receive portion of the duty cycle.

The training process may similarly detect a subsequent envelope of the subsequent wireless signal and updating a transmit-receive schedule based on the detected subsequent envelope. In some embodiments, the slave base station enters the training mode for a single cycle (1 duty cycle) while in other embodiments, the slave enters the training mode for a pre-determined plurality of cycles. Still in other embodiments, the slave enters the training mode for a pre-determined duration of time, for example, as identified by a timer.

In some embodiments, the training mode and SYNC RX 130 are disabled during normal operation. In other embodiments, the SYNC RX 130 and processor 150 are actively or periodically monitoring the receive window during normal operation to detect if the receive window is narrowing because of drift.

In some embodiments, drift is reduced by rebooting the slave base station and beginning the start-up process again. For example, after a reboot, the base station determines it is configured in as a slave base station. It may then proceed as described above by delaying a predetermined about of time and entering the training mode or by entering the training mode until it times out.

The description above provides various hardware embodiments of the present invention. Furthermore, the figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Therefore, it should be understood that the invention could be practiced with modification and alteration within the spirit and scope of the claims. For example, the invention is not limited to any one wireless standard and one skilled in wireless technology would see in light of this disclosure that the invention applies to any multi-sector wireless base station or hub, operating at any frequency band. The description is not intended to be exhaustive or to limit the invention to the precise form disclosed. It should be understood that the invention could be practiced with modification and alteration.

What is claimed is:

1. A method of synchronizing co-located wireless base stations, the method comprising:
receiving, during a training mode at a wireless receiver of a first base station, a first wireless signal transmitted from a second base station;
detecting an envelope of the first wireless signal;
determining a transmit-receive schedule based on the detected envelope;
switching from the training mode to an operational mode after the act of determining the transmit-receive schedule;
transmitting, during a first duration determined by the transmit-receive schedule, a downlink signal; and
receiving, during a second duration determined by the transmit-receive schedule, an uplink signal.

2. The method of claim 1, wherein the act of determining the transmit-receive schedule comprises synchronizing a start-of-transmission time at the first base station corresponding to an edge of the detected envelope.

3. The method of claim 1, wherein the act of determining the transmit-receive schedule comprises running a phase locked loop (PLL) at a rate of the detected envelope.

4. The method of claim 1, wherein the act of determining the transmit-receive schedule comprises
determining the first duration based on a duration between a first and a second edge of the detected envelope;
determining the second duration based on a duration between a second and a subsequent first edge of the detected envelope; and
determining a duty-cycle parameter based on the first duration and second duration.

5. The method of claim 1, wherein the act of determining the transmit-receive schedule comprises determining the first duration based on a pre-configured duty-cycle parameter.

6. The method of claim 1, further comprising re-synchronizing, the act of re-synchronizing comprising:
re-initiating the training mode; and
receiving, during the training mode at the wireless receiver of the first base station, a subsequent wireless signal transmitted from the second base station;
detecting a subsequent envelope of the subsequent wireless signal; and
updating a transmit-receive schedule based on the detected subsequent envelope.

7. The method of claim 1, further comprising forcing a re-synchronizing, the act of re-synchronizing comprising:
detecting an invalid envelope;
re-initiating the training mode; and
receiving, during the training mode at the wireless receiver of the first base station, a subsequent wireless signal transmitted from the second base station;
detecting a subsequent envelope of the subsequent wireless signal; and
updating a transmit-receive schedule based on the detected subsequent envelope.

8. The method of claim 1, further comprising:
determining the first base station is configured in a slave base station mode;
delaying a predetermined about of time; and
entering the training mode.

9. The method of claim 1, further comprising:
rebooting the first base station;
determining the first base station is configured in a slave base station mode;
delaying a predetermined about of time; and
entering the training mode.

10. A method synchronizing co-located wireless base stations comprising a first base station and remaining base stations, each of the base stations initially configured as a slave-mode base station, the method comprising:
setting a random variable, in each of the co-located wireless base stations, to indicate a different period of time;
monitoring, in each of the co-located wireless base stations, for an envelope from a master base station;
detecting, in the first base stations, a time out indicated by the different period of time;
changing, in the first base stations and in response to the time out, from the slave-mode base station to a master-mode base station and entering a master mode;
detecting, in each of the remaining base stations, an envelope of the first wireless signal;
determining, in each of the remaining base stations, a transmit-receive schedule based on the detected envelope;
switching, in each of the remaining base stations, from the training mode to an operational mode after the act of determining the transmit-receive schedule;
transmitting, in each of the remaining base stations, during a first duration determined by the transmit-receive schedule, a downlink signal; and
receiving, in each of the remaining base stations, during a second duration determined by the transmit-receive schedule, an uplink signal.

11. A wireless base station to for synchronizing with one or more other co-located wireless base stations, the wireless base station comprising:
a transmit/receive switch comprising a transmit signal input port, a receive signal output port, a transmit signal enable control port and an antenna port;
a transmitter comprising a transmit signal enable control port and a transmit signal output port coupled to the transmit signal input port of the transmit/receive switch;
a first receiver for operation during a operational mode, wherein the first receiver has an input port coupled to the receive signal output port of the transmit/receive switch and an output port;
a second receiver for a training mode, wherein the second receiver comprises an input port coupled to the receive signal output port of the transmit/receive switch and an output port;
a controller comprising a first input port coupled to the output port of the first receiver, a second input port coupled to the output port of the second receiver, and an output port coupled to the transmit signal enable control port of the transmit/receive switch and to the transmit signal enable control port of the transmitter, wherein the controller further comprises a timing circuit and code to:
receive, during the training mode, a first wireless signal transmitted from a second base station;
detect an envelope of the first wireless signal;
determine a transmit-receive schedule based on the detected envelope;
switch from the training mode to the operational mode after determining the transmit-receive schedule;
transmit, during a first duration determined by the transmit-receive schedule, a downlink signal; and
receive, during a second duration determined by the transmit-receive schedule, an uplink signal.

12. The wireless base station of claim 11, wherein the second receiver further comprises a receive path comprising an amplifier, a filter, a rectifier circuit and a comparator circuit.
